(19) United States
(12) Patent Application Publication
(10) Pub. No.: US 2015/0287236 A1
(43) Pub. Date: Oct. 8, 2015

(54) IMAGING SYSTEM, OPERATING DEVICE WITH THE IMAGING SYSTEM AND METHOD FOR IMAGING

(71) Applicants: FRAUNHOFER-GESELLSCHAFT ZUR FÖRDERUNG DER ANGEWANDTEN FORSCHUNG E.V., München (DE); CHARITÉ UNIVERSITÄTSMEDIZIN BERLIN TECHNOLOGIETRANSFERSTELLE, Berlin (DE)

(72) Inventors: Christian Winne, Berlin (DE); Sebastian Engel, Muenster (DE); Erwin Keeve, Potsdam (DE); Eckart Uhlmann, Kiebitzreihe (DE)

(21) Appl. No.: 14/440,438

(22) PCT Filed: Nov. 4, 2013
(86) PCT No.: PCT/EP2013/072926

§ 371 Date: May 4, 2015

(30) Foreign Application Priority Data
Nov. 5, 2012 (DE) 10 2012 220 115.7

(51) Int. Cl. G06T 15/08; G06F 3/147; G06T 7/20; G06T 17/30; H04N 5/225; G06T 11/00

(52) U.S. Cl. CPC G06T 15/08; H04N 5/225; G06T 11/001; G06T 7/208; G06T 17/30; G06F 3/147; H04N 2005/2255; G06T 2215/16; G06T 2207/10004; G06T 2207/10016; G06T 2207/10024; G06T 2207/10028; G06T 2207/10068

(57) ABSTRACT

The invention relates to an imaging system 200, in particular for a surgical device 1000 with a mobile handheld device head 100, comprising:
an image data acquisition unit 210 with an image recording unit, in particular a surgical camera 211, 212, which is embodied to register image data 300 of operation surroundings OU,
an image data processing unit 220, which is embodied to provide the image data,
an image storage unit 230, which is embodied to store the image data 300 of the operation surroundings and volume data of a volume rendering 320 associated with the operation surroundings. According to the invention, provision is furthermore made for
registration means 260, which are embodied to localize the image recording unit, in particular the surgical camera 211, 212, relative to the operation surroundings,
virtual pointer means 250, which are embodied automatically to provide, in particular identify and/or display, a number of surface points OS of the image data 300, and
assignment means, in particular with computer means 240, which are embodied to assign to at least one of the provided surface points OS automatically a volume point VP of the volume rendering 320.

Imaging system, surgical device with the imaging system and imaging method

The invention relates to an imaging system, in particular for a surgical device, comprising: an image data acquisition unit, an image data processing unit, an image storage unit. The invention furthermore relates to a surgical device. The invention also relates to an imaging method, comprising the following steps: registering and providing image data and storing the image data, in particular in the medical or nonmedical field.

Approaches for the mobile handheld device of the type set forth at the outset have been developed, particularly in the medical field. Currently, the approach of an endoscopic navigation or instrument navigation, in particular, is pursued for displaying a guide apparatus, in which approach optical or electromagnetic tracking methods are used for navigation; by way of example, modular systems for an endoscope with expanding system modules such as a tracking camera, a computer unit and an visual display unit for rendering a clinical navigation are known.

In principle, tracking should be understood to mean a method for tracing or updating, which serves the tracking of moved objects—namely, in the present case, the mobile device head. The goal of this tracking usually lies in imaging the observed actual movement, in particular relative to charted surroundings, for the purposes of technical use. This can be the bringing together of the tracked (guided) object—namely the mobile device head—and another object (e.g. a target point or a target trajectory in the surroundings) or merely the knowledge of the current “pose”—i.e. position and/or orientation—and/or movement state of the tracked object.

Until now, absolute data relating to the position and/or orientation (pose) of the object and/or relating to the movement of the object are regularly used for tracking purposes, for example in the system specified above. The quality of the determined pose and/or movement information depends, first of all, on the quality of the observation, the employed tracking algorithm and the model formation, which serves to compensate unavoidable measurement errors. However, without forming a model, the quality of the determined location and movement information is usually comparatively bad. Currently, absolute coordinates of a mobile device head—e.g. within the scope of a medical application—are also deduced e.g. from the relative relationship between a patient tracker and a tracker for the device head. In principle, a problem of such modular systems, which are referred to as tracking-absolute modules, is the additional outlay—spatially and temporally—for displaying the required tracker. The spatial requirements are huge and found to be very problematic in an operating theater with a multiplicity of participants.

Thus, moreover, sufficient navigation information must be available; i.e. during tracking methods, a data signal connection between a tracker—e.g. a localizer described in more detail below—and an image data acquisition unit—e.g. a localizer acquisition system—should be regularly maintained, for example be maintained to a tracking camera—or a different acquisition module of a localizer acquisition system. By way of example, this can be an optical or else an electromagnetic signal connection or the like. In particular, if such an optical signal connection is dropped—e.g. if a participant finds himself in the image recording line between tracking camera and a patient tracker—there is a lack of necessary navigation information. In this case, guiding the device head is no longer supported by navigation information. In an exceptional case, it is possible to interrupt the guiding of the mobile device head until navigation information is available again. This problem is known as the so-called “line of sight” problem, particularly in the case of the optical signal connection.

Although a more stable signal connection can be provided by means of e.g. electromagnetic tracking methods, which is less susceptible than an optical signal connection, such electromagnetic tracking methods are necessarily less precise and more sensitive in relation to electrically conductive or ferromagnetically conductive objects in the measurement space; this is relevant, particularly in the case of medical applications, since the mobile handheld device should regularly serve to assist in surgical interventions or the like, and so the presence of electrically or ferromagnetically conductive objects in the measurement space, i.e. of the operation point, may be the norm.

It is desirable to largely avoid, reduce and/or circumvent a problem connected to the above-described conventional navigation tracking sensor system for a mobile handheld device. In particular, this relates to the problems of the aforementioned optical or electromagnetic tracking methods. Nevertheless, an accuracy of a guide apparatus for navigation should be as high as possible in order to enable a robotics application, which is as precise as possible, closer to the mobile handheld device, in particular in order to enable a medical application of the mobile handheld device.

However, moreover, there is also the problem that the invariance of a spatially fixed position of a patient tracker or locator is decisive for the accuracy of the tracking in the patient registration; this likewise cannot always be ensured in practice in an operating theater with a multiplicity of participants. In principle, a mobile handheld device with a tracking system which has been improved in this respect is known from WO 2006/131373 A2, wherein the device is embodied in an advantageous manner for contactlessly establishing and measuring s spatial position and/or spatial orientation of bodies.

New approaches, particularly in the medical field, attempt to assist the navigation of a mobile device head with the aid of intraoperative magnetic resonance imaging or general computed tomography by virtue of said device heads being coupled to an imaging unit. The registration of image data, for example obtained by means of endoscopic video data, with a CT recording obtained prior to surgery is described in the article by Mirota et al.: “A system for Video-Based Navigation for Endoscopic Endonasal Skull Base Surgery”, IEEE Transactions on Medical Imaging, volume 31, number 4, April 2012 or in the article by Burschka et al.: “Scale-invariant registration of monocular endoscopic images to CT-scans for sinus surgery”, in Medical Image Analysis 9 (2005), 413-426. An essential goal of registering image data obtained by means of e.g. endoscopic video data lies in improving the accuracy of the registration.

However, on the other hand, such approaches are comparatively inflexible because a second image data source must always be prepared, e.g. in a CT scan prior to surgery. Moreover, CT data are connected to a large outlay and high costs. The acute and flexible availability of such approaches at any desired time, e.g. spontaneously within an operation, is therefore not possible or only possible to a restricted extent and with preparation.

The newest approaches predict the possibility of using methods for simultaneous localization and mapping “in vivo” for navigation purposes. By way of example, a basic study in this respect was described in the article by Mountney et al. for the 31^{st} Annual

International Conference of the IEEE EMBS Minneapolis, Minnesota, USA, Sep. 2-6, 2009 (978-1-4244-3296-7/09). A real-time application at 30 Hz for a 3D model within the scope of a visual SLAM with an extended Kalman filter (EKF) is described in the article by Grasa et al.: “EKF monocular SLAM with relocalization for laparoscopic sequences” in 2011 IEEE International Conference on Robotics and Automation, Shanghai, May 9-13, 2011 (978-1-61284-385-8/11). The pose (position and/or orientation) of an image data acquisition unit is taken into account in a three-point algorithm. A real-time usability and the robustness in view of a moderate level of object movement were tested.

Like in the aforementioned article by Mountney et al., Totz et al. in Int J CARS (2012) 7:423-432: “Enhanced visualization for minimally invasive surgery” describes that a field of view of an endoscope can be expanded using a so-called dynamic view expansion; this is based on observations made previously. The method uses an approach for simultaneous localization and mapping (SLAM).

In principle, such methods are promising; the renderings however are currently unable to show how a handheld property could be implemented in practice. In particular, the aforementioned article by Mirota et al. shows that the registration of image data from the visual recording of an operation surrounding by means of a surgical camera to image material obtained prior to surgery such as e.g. CT data—i.e. the registration of the current two-dimensional surface data to a three-dimensional volume rendering prior to surgery—can be implemented in different ways, namely on the basis of a point instrument, a tracker or a visual navigation.

In general, reference is made to such methods and other methods than the so-called registration methods.

Registration systems on the basis of physical pointers regularly comprise so-called localizers, namely a first localizer to be attached to the patient for displaying the coordinate system of the patient and an instrument localizer for displaying the coordinate system of a pointer or an instrument. The localizers can be registered by a 3D measurement camera, e.g. by means of a stereoscopic measurement camera, and the two coordinate systems can be linked within the scope of the image processing and navigation.

A problem of the aforementioned approaches using physical pointer means is that the use of physical pointer means is comparatively complicated and also susceptible to errors in the implementation thereof. The accuracy is problematic in only visual registration and navigation approaches, which accuracy is ultimately determined by the resolution of the employed surgical camera. An approach which is comparatively robust in relation to interference and implementable with a reduced outlay and nevertheless available with comparatively high resolution would be desirable.

The invention starts from this point; the object thereof is to specify an imaging system and a surgical device and a method by means of which a surface model of the operation surrounding can be registered to a volume rendering of the operation surroundings in an improved manner. In particular, handling and availability of registered operation points should be improved.

The object in relation to the system is achieved by an imaging system of claim 1.

The imaging system for the surgical device with a mobile handheld device head comprises:
an image data acquisition unit with an image recording unit, in particular a surgical camera, which is embodied to register image data of operation surroundings,
an image data processing unit, which is embodied to provide the image data,
an image storage unit, which is embodied to the image data of the operation surroundings and volume data of a the operation surroundings. According to the invention, provision is furthermore made for:
registration means, which are embodied to localize the image recording unit, in particular the surgical camera, relative to the operation surroundings,
virtual pointer means, which are embodied automatically to provide, in particular identify and/or display, a number of image points of the image data (300), and
assignment means, in particular with computer means, which are embodied to assign to at least one of the provided image points automatically a volume point of the volume rendering.

The image points are particularly preferably specifiable as surface points.

It is particularly preferable for the image data to comprise surface rendering data and/or for the volume data to comprise volume rendering data. Within the scope of a particularly preferred development, the image data processing unit is embodied to generate a surface model of the operation surroundings by means of the image data, and/or
an image storage unit is embodied to store the surface model rendering data, and/or
the registration means are embodied to localize the surgical camera relative to the surface model of the operation surroundings, and/or
the virtual pointer means are embodied to provide a number of surface points in the surface model.

In principle, the image recording unit can comprise any type of imaging device. Thus, the image recording unit can preferably be a surgical camera, which is directed to the operation surroundings. Preferably, an image recording unit can have an optical camera. However, an image recording unit can also comprise a different type to the optical one in the visible range in order to act in an imaging manner for real or virtual images. By way of example, the image recording unit can operate on the basis of infrared, ultraviolet or x-ray radiation. Moreover, the image recording unit can comprise an apparatus that is able to generate a planar, possibly arbitrarily curved topography from volume images, i.e., in this respect a virtual image. By way of example, this can also be a slice plane view of a volume image, for example in a sagittal, frontal or transverse plane of a body.

The object in relation to the device is achieved by a surgical device of claim 18.

An aforementioned surgical device can preferably in a periphery have a mobile handheld device head. The mobile handheld device head can in particular have a tool, an instrument or sensor or similar apparatus. Preferably, the device head is designed in such a way that it has an image recording unit, as may be the case in e.g. an endoscope. However, the image recording unit can also be used at a distance from the device head, in particular for observing the device head, in particular for observing a distal end of same in operation surroundings.

In particular, the surgical device can be a medical device with a medical mobile device head, such as an endoscope, a pointer instrument or a surgical instrument or the like, with a distal end for arrangement relative to a body, in particular body tissue, preferably for introduction into, or attachment to, the body, in particular to a body tissue, in particular for treatment or observation of a biological body such as a tissue-like body or similar body tissue.

In particular, an aforementioned surgical device can be a medical device, such as an endoscope, a pointer instrument or a surgical instrument with peripherals, which is employable e.g. within the scope of laparoscopy or another medical examination process with the aid of an optical instrument; such approaches have particularly proven their worth in the field of minimally invasive surgery.

In particular, the device can be a nonmedical device with a nonmedical mobile device head, such as an endoscope, a pointer instrument or a tool or the like, with a distal end for arrangement relative to a body, in particular a technical object such as a device or an apparatus, preferably for introduction into, or attachment to, the body, in particular to an object, in particular for machining or observation of a technical body, such as an object or apparatus or similar device.

The aforementioned system can also be used in a nonmedical field of application. The aforementioned system can be useful in a nonmedical field of application, e.g. for assisting in the visualization and analysis of nondestructive testing methods in industry (e.g. material testing) or in everyday life (e.g. airport checks or bomb disposal). Here, for example, a camera-based visual inspection from afar (e.g. for protection against dangerous contents) with the aid of the present invention can, analysis and assessment of the inner views on the basis of previously or simultaneously recorded image data (e.g. 3D x-ray image data, ultrasound image data or microwave image data, etc.), increase the safety and/or reduce the work outlay. A further exemplary application is examination of inner cavities of components or assemblies with the aid of the system presented here, for example on the basis of an endoscopic or endoscope-like camera system.

The concept of the invention has likewise proven its worth in nonmedical fields of application where a device head is expediently used. In particular, the use of optical sighting instruments is useful in assembly or repair. By way of example tools, particularly in the field of robotics, can be attached to an operation device which is equipped with an imaging system such that the tools can be navigated by means of the operation device. The system can increase the accuracy, particularly during the assembly of industrial robots, or it can realize assembly activities which were previously not possible using robots. Moreover, the assembly activity can be simplified for a worker/mechanic by instructions of data processing on the basis of the imaging system set forth at the outset attached to the tool thereof. By way of example, with the aid of data processing, the scope of the work can be reduced by assistance and/or the quality of the carried out activity can be increased by monitoring by using this navigation option in conjunction with an assembly tool, for example a cordless screwdriver, on a structure (e.g. a vehicle body), the assembly (e.g. screw-in connection of spark plugs), of a component (e.g. spark plug or screw).

In general terms, the surgical device of the aforementioned type can preferably be equipped with a manual and/or automatic guidance for guiding the mobile device head, wherein a guide apparatus is embodied for navigation purposes in order to enable automatic guidance of the mobile device.

The object relating to the method is achieved by a method of claim 19.

The invention is equally applicable to a medical field and a nonmedical field, in particular in a noninvasive manner and without physical intervention on a body.

The method can preferably be restricted to a nonmedical field.

DE 10 2012 211 378.9, which was not published at the time of filing the present application and the priority of which was prior to the application date of the present application, has disclosed a mobile handheld device with a mobile device head, in particular a medical mobile device head with a distal end for arrangement relative to a body tissue, which, attached to a guide apparatus, is guidable with inclusion of an image data acquisition unit, an image data processing unit and a navigation unit. To this end, image data and an image data stream are used to specify at least a position and orientation of the device head in operation surroundings on the basis of a map.

The invention proceeds from the deliberation that, during the registration of a volume rendering on a surface model of the operation surroundings, the surgical camera was previously only used as image data recording means, independently of the type of registration. The invention has identified that, moreover, the surgical camera—if it is localized relative to the surface model, in particular registered in relation to the surface model and the volume rendering of the operation surroundings—can be used to generate a virtual pointer means. Accordingly, the following is provided according to the invention:
registration means, which are embodied to localize the surgical camera relative to the operation surroundings;
virtual pointer means, which are embodied automatically to provide a number of surface points in the surface model;
computer means which are embodied to assign to at least one of the provided surface points automatically a volume point of the volume rendering.

The invention has identified that the use of a physical pointer means can be dispensed with in most cases as a result of a virtual pointer means generated thus. Rather, a number of surface points can be provided in an automated manner in such a way that a surgeon or other user merely needs to be put into a position to effectively select the surface point of interest to him; the selection process is more effective and more quickly available than a cumbersome use of a physical pointer means. Rather, a number of surface points in the surface model can automatically be provided with a respectively assigned volume point of the volume rendering in an automatic manner and with justifiable outlay. This leads to effective registration of the surface point to the point of the volume rendering assigned to the surface point.

The concept of the invention is based on the discovery that registering the surgical camera relative to the surface model also enables the registration in relation to the volume rendering of the operation surroundings and hence it is possible to assign a surface point to a volume rendering in a unique way. This can be performed for a number of points with justifiable computational outlay and these points can be provided to the surgeon or other user in an effective manner as a selection. This provides the surgeon or other user with the option of viewing, in the surface model and the volume rendering, any object imaged in the image of the operation surroundings, i.e. objects at specific but freely selectable points of the operation surroundings. This also makes points in the operation surroundings accessible which were inaccessible with the physical pointer instrument.

This option is presented independently of the registration means for the surgical camera; said registration means can comprise a registration by means of external localization of the surgical camera (e.g. by tracking and/or a pointer) and/or comprise an internal localization by evaluating the camera image data (visual process by the camera itself).

Advantageous developments of the invention can be gathered from the dependent claims and, in detail, these specify advantageous options for realizing the explained concept within the scope of the problem and in view of further advantages.

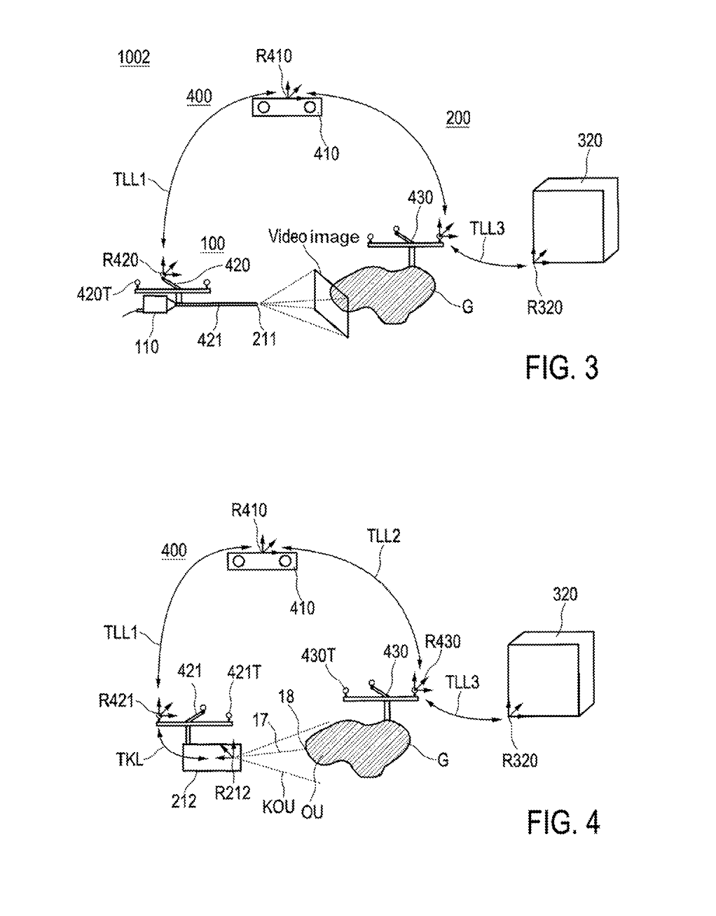

In a first variant, the registration means preferably comprises a physical patient localizer, a physical camera localizer and an external, optical localizer registration system. A particularly preferred embodiment is explained in FIG. 3 and FIG. 4 of the drawings.

By using physical localizers, the aforementioned developing first variant significantly increases the accuracy of a registration, i.e. a registration between image and volume rendering or between image data and volume data, in particular between surface model and volume rendering of the operation surroundings. However physical registration means can, for example, also be subject to a change in position relative to the characterized body, for example as a result of slippage or detachment relative to the body during an operation. This can be countered since the surgical camera is likewise registered by a localizer.

In particular, the image or the image data, in particular the surface model, can advantageously be used in the case of a loss of the physical registration means or in the case of an interruption in the visual contact between an optical position measurement system and a localizer to establish the pose of the surgical camera relative to the operation surroundings. That is to say, even if a camera localizer is briefly no longer registered by an external, optical localizer registration system, the pose of the surgical camera relative to the operation surrounding can be back-calculated from the surface model for the duration of the interruption. This effectively compensates a fundamental weakness of a physical registration means.

In particular, a combination of a plurality of registration means—e.g. an optical position measurement system from the first variant and a visual navigation from the second variant explained below—can be used in such a way that an identification of errors, e.g. the slippage of a localizer, becomes possible. This allows transformation errors to be rectified and corrected quickly by virtue of a comparison being made between an intended value of the one registration means and an actual value of the other registration means. The variants which, in principle, develop the concept of the invention independently can equally be used redundantly in a particularly preferred manner, in particular be used for the aforementioned identification of errors.

In a second developing variant, the registration means can substantially be embodied for the virtual localization of the camera. The registration means, which are referred to as virtual here, comprise, in particular, the image data registration unit, the image data processing unit and a navigation unit. In accordance with the second variant of a development, provision is made, in particular, for
the image data acquisition unit to be embodied to register and provide, in particular continuously, image data of surroundings of the device head and
the image data processing unit to be embodied to generate a map of the surroundings by means of the image data and
the navigation unit to be embodied, by means of the image data and an image data stream, to specify at least one position of the device head in close surroundings of the operation surroundings on the basis of the map in such a way that the mobile device head is guidable on the basis of the map.

In principle, navigation should be understood to mean any type of map generation and specification of a position in the map and/or the specification of a target point in the map, preferably in relation to position; thus, furthermore, determining a position in relation to a coordinate system and/or specifying a target point, in particular specifying a route, which is advantageously visible in the map, between position and target point.

The development proceeds from substantially image data-based mapping and navigation in a map for the surroundings of the device head in a broad sense, i.e. surroundings which are not restricted to close surroundings of the distal end of the device head, such as e.g. the visually registrable close surroundings at the distal end of an endoscope—the latter visually registrable close surroundings are referred to here as operation surroundings of the device head.

Particularly advantageously, a guide means with a position reference to the device head can be assigned to the latter. The guide means is preferably embodied to provide information in relation to the position of the device head with reference to the surroundings in the map, wherein the surroundings go beyond the close surroundings.

The position reference of the guide means to the device head can advantageously be rigid. However, the position reference need not be rigid as long as the position reference is changeable or movable in a determined fashion or can be calibrated in any case. By way of example, this can be the case if the device head at the distal end of a robotic arm is part of a handling apparatus and the guide means is attached to a robotic arm, like e.g.

variants caused by errors or expansions, the non-rigid but, in principle, deterministic position reference between guide means and device head can be be calibrated in this case.

An image data stream should be understood to mean the stream of image data points changing over time, which is generated if a number of image data points are observed at a first and a second time with changes in the position, the direction and/or velocity of same for a defined passage surface.

The guide means preferably, but not necessarily, comprises the image data registration.

Within the scope of a preferred development, a surface coordinate of the surface model rendering data is assigned to the surface point in the surface model. Preferably, the volume point of the volume rendering has a volume coordinate which is assigned to the volume rendering data. The data can be stored in the image storage unit in a suitable format, such as e.g. a data file or data stream or the like.

The surface point can preferably be set as a point of intersection between a virtual visual beam emanating from the surgical camera and the surface model. In particular, a surface coordinate can be specified as an image point of the surgical camera assigned to the point of intersection. After registering the surgical camera relative to the surface model and in the case of registered volume rendering of 3D image data, such a 2D image point can be registered to the patient or to the surface model and the camera itself can also be localized in the volume image data or localized relative thereto.

Preferred developments moreover specify advantageous options for providing a selection or a determination of a surface point relative to a volume point.

Preferably, provision is made for a selection and/or monitoring means, which is embodied to group the freely selectable and automatically provided and set number of surface points in a selection and to visualize the selection in a selection rendering. The selection rendering can be an image, but also a selection menu or a list or other rendering. The selection rendering can also be a verbal rendering or sensor feature.

In particular, it was found to be preferable for the number of surface points in the surface model to be freely selectable, in particular free from a physical display, i.e. for these to be provided without a physical pointer means. The number of surface points in the surface model can, particularly preferably, be provided by virtual pointer means only. Equally, the system in accordance with the aforementioned development is also suitable for allowing physical pointer means and enabling these for localizing a surface point relative to a volume rendering.

The number of surface points in the surface model can be set automatically within the scope of a development. Hence, in particular, there is no need for further automated evaluation or interaction between surgeon or other user and selection in order to register a surface point to a volume point and display this.

It was equally found to be advantageous for the selection to comprise at least an automatic pre-selection and an automatic final selection. Advantageously, the at least one automatic pre-selection can comprise a number of cascaded automatic pre-selections such that, with corresponding interaction between selection and surgeon or other user, a desired final selection of a registered surface point to a volume point is finally available.

Within the scope of a further particularly preferred embodiment, it was found to be advantageous for a selection and/or monitoring means to be embodied to group the automatic selection of the basis of the image data and/or the surface model. This relates to the pre-selection in particular. However, additionally or alternatively, this can also relate to the final selection, in particular to an evaluation method for the final selection.

A grouping can be implemented on the basis of first grouping parameters; these comprise a distance measure, in particular a distance between the surgical camera and structures depicted in the image data. The grouping parameters preferably also comprise a 2D and/or 3D topography, in particular a 3D topography of depicted structures on the basis of the generated surface model; this can comprise a form or a depth gradient of a structure. The grouping parameters preferably also comprise a color, in particular a color or color change of the depicted structure in the image data.

Such an automatic selection grouped substantially on the basis of the image data and/or the surface model can be complemented by an automatic selection which is independent of the image data and/or independent of the surface model. To this end, second grouping parameters, in particular, are suitable; these comprise a geometry prescription or a grid prescription. By way of example, a geometric distribution of image points for the selection of surface points registered to volume points and/or a rectangular or circular grid can be predetermined. In this way, it is possible to select points which correspond to a specific geometric distribution and/or which follow a specific form or which lie in a specific grid, such as in a specific quadrant or in a specific region for example.

An automatic final selection can particularly preferably be implemented by means of evaluation methods from the points provided in a pre-selection; in particular, selected positions can then be grouped by means of evaluation methods within the scope of the automatic final selection. By way of example, the evaluation methods comprise methods for statistical evaluation in conjunction with other image points or image positions. Here, mathematical filter and/or logic processes, such as a Kalman filter, a fuzzy logic and/or neural network, are suitable.

An interaction with the selection and/or monitoring means, i.e., in particular, a manual interaction between a surgeon or other user and the selection and/or monitoring means can particularly preferably be implemented within the scope of a manual selection assistance by one or more input features. By way of example, an input feature can be a keyboard means for the hand or foot of the surgeon or other user; by way of example, this can be a computer mouse, a key, a pointer or the like. A gesture sensor which reacts to a specific gesture can also be employed as input means. A voice sensor or touch-sensitive sensor such as e.g. an input pad is also possible. Moreover, other mechanical input devices, such as keyboards, control buttons or pushbuttons, are also suitable.

The concept or one of the developments is found to be advantageous in many technical fields of application, such as e.g. robotics, particularly in medical engineering or in a nonmedical field. Thus, the subject matter of the claims in particular comprises a mobile handheld medical device and an in particular noninvasive method for treating or observing a biological body such as a tissue or the like. An image recording unit can, in particular, have an endoscope or an ultrasound imaging unit or any other imaging unit, in particular an aforementioned unit, e.g. on the basis of IR, x-ray or UV radiation. Thus, for example, 2D slice images or 3D volume images can also be registered to the operation surroundings in the case of a tracked and calibrated ultrasonic probe. By way of example, by segmenting significant and/or characteristic grayscale value changes, it is also possible to calculate surface models from the image data, which surface models can serve as a basis for the virtual pointer means or the selection and/or monitoring means. The use of ultrasound imaging or any other radiation-based imaging as an image recording unit is particularly advantageous. By way of example, a device head can also be a pointer instrument or a surgical instrument or a similar medical device for treating or observing a body, or serve to register its own position or the instrument position relative to the surroundings.

Thus, the subject matter of the claims in particular comprises a mobile handheld nonmedical device and an in particular noninvasive method for treating or observing a technical body such as an object or a device or the like. By way of example, the concept can be successfully applied to industrial processing, positioning or monitoring processes. However the described concept substantially based on image data is also advantageous for other applications in which a claimed mobile handheld device can be used according to the above-described principle—for example within the scope of an instrument, tool or sensor-like system.

Exemplary embodiments of the invention will now be described below on the basis of the drawing with a comparison being made to the prior art, which is partly likewise depicted—to be precise, this is done in the medical scope of application, in which the concept is implemented in relation to a biological body; similarly, the exemplary embodiments also apply to a nonmedical scope of application, in which the concept is implemented in relation to a technical body.

The drawing should not necessarily depict the exemplary embodiments true to scale; rather, the drawing is embodied in a schematic and/or slightly distorted form where this serves the explanations. Reference is made to the relevant prior art in view of complements to the teachings directly identifiable from the drawing. It should be noted here that multifaceted modifications and changes relating to the form and the detail of an embodiment can be undertaken without deviating from the general concept of the invention. The features of the invention disclosed in the description, in the drawing and in the claims can be essential for developing the invention, both on their own and in any combination. Moreover, all combinations of at least two of the features disclosed in the description, the drawing and/or the claims fall within the scope of the invention. The general concept of the invention is not restricted to the exact form or the detail of the preferred embodiment which is shown and described below; nor is it restricted to subject matter which would be restricted compared to the subject matter claimed in the claims. In the case of the specified dimension ranges, values lying within the specified boundaries should also be disclosed and used, as desired, and claimed as boundary values. Further advantages, features and details of the invention emerge from the following description of the preferred exemplary embodiments and on the basis of the drawing; in detail:

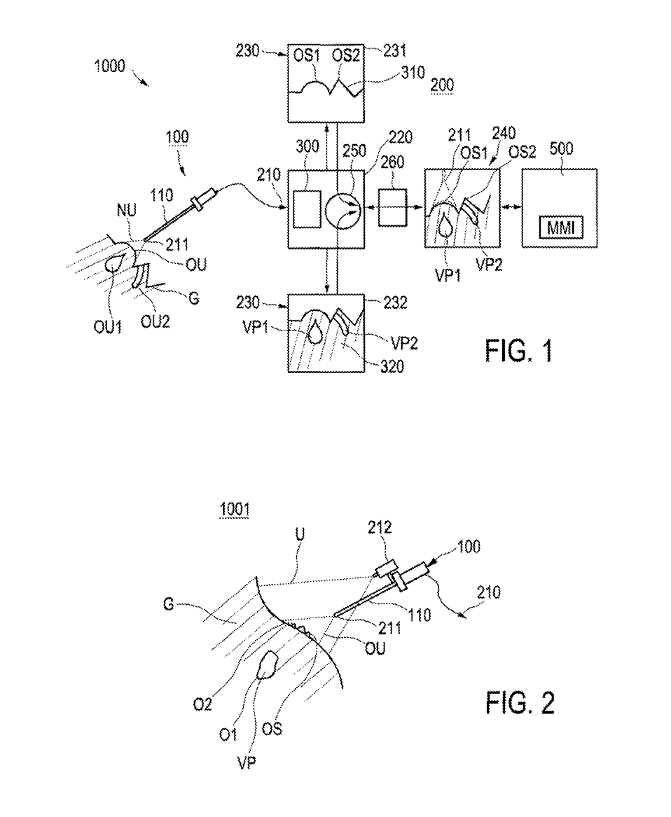

FIG. 1 shows a basic scheme of a method and a device for imaging with registering a surface model to a volume rendering taking into account the surgical camera, namely selectively based on a physical pointer means, a tracker, or based on a visual navigation process;

FIG. 2 shows an exemplary embodiment of a surgical device with an imaging system, in which the registration of the surgical camera is based decisively on a visual navigation procedure, in particular as described in DE 10 2012 211 378.9 set forth at the outset, the disclosure of which is herewith completely incorporated into the disclosure of this application by reference;

FIG. 3 shows an alternative embodiment of a surgical device with an imaging system, in which localizers are provided not only to localize the patient but also the surgical camera by way of an endoscope localizer such that a virtual pointer means can be embodied to automatically provide a number of surface points in the surface model—to this end, an endoscope is shown in an exemplary manner as a specific camera system;

FIG. 4 shows a development of the embodiment of a surgical device depicted in FIG. 3, in which a second localizer is attached directly to the surgical camera instead of on the endoscope—the transformation TKL, to be calibrated, between camera localizer and camera origin (lens) becomes clear, with the camera being depicted by a camera symbol which, in general, represents any advantageously employable camera;

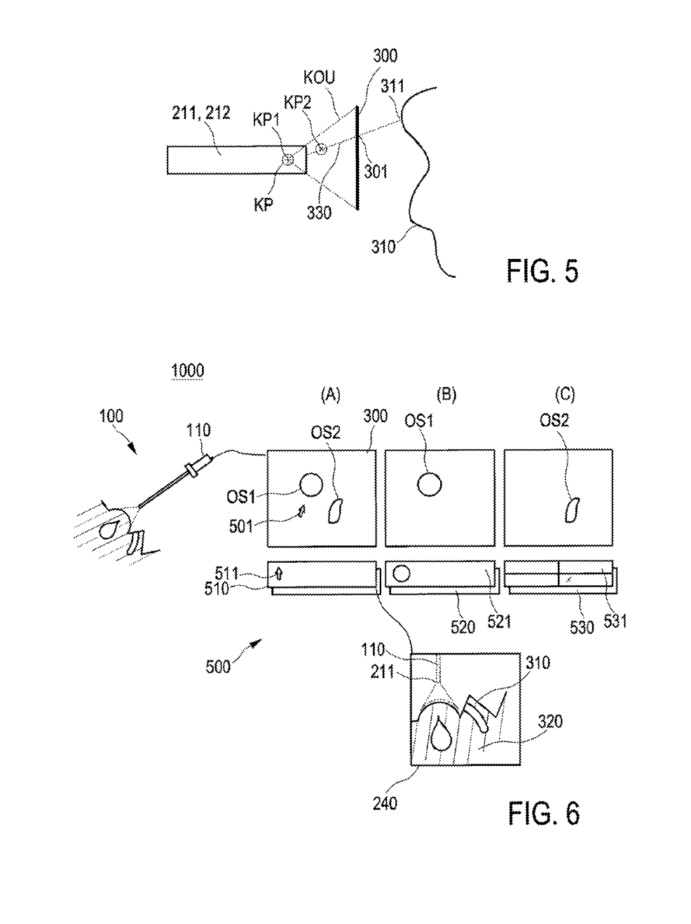

FIG. 5 shows a detail X of FIG. 3 or FIG. 4 for elucidating a preferred procedure for determining a surface point as point of intersection between a virtual visual beam emanating from the surgical camera and the surface model;

FIG. 6 shows a flowchart for elucidating a preferred method for implementing an automatic pre-selection and an automatic final selection by means of a selection and/or monitoring means, which uses first and second grouping parameters in order to provide at least one surface point with assigned volume point;

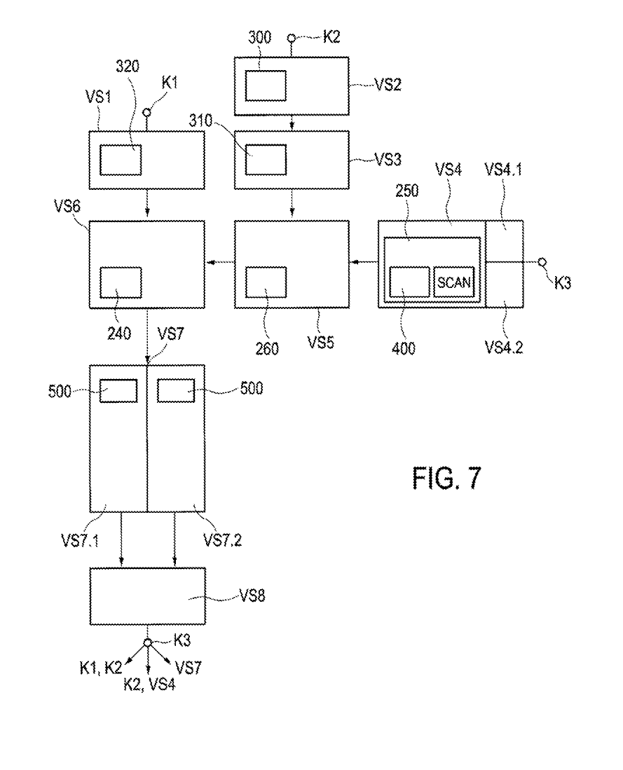

FIG. 7 shows a flowchart for a particularly preferred embodiment of a process for navigating any image points in medical camera image data of a surgical camera.

In the description of the figures and with reference to the corresponding parts of the description, the same reference signs have been used throughout for identical or similar features or features with an identical or similar function. Below, a device and a method are presented in various embodiments which are particularly preferably suitable for clinical navigation, but which are not restricted thereto.

In the case of clinical navigation, it is possible within the scope of image-assisted interventions, such as e.g. endoscopic interventions or other laparoscopic interventions, on tissue structures G to calculate for any image points in the camera image the corresponding position in 3D image data of a patient. In the following, various options for determining 3D positions, the objects depicted in the camera image data and the use thereof for clinical navigation are described in detail. Initially, as an overview image of the principle, FIG. 1 shows the general structure of a method or a device for clinical navigation.

To this end, FIG. 1 shows a surgical device 1000 with a mobile handheld device head 100 and an imaging system 200. The device head 100 is presently formed in the shape of an endoscope 110. An image data acquisition unit 210 of the imaging system 200 has a surgical camera 211 at the endoscope, said surgical camera being embodied to continuously register and provide image data 300 of operation surroundings OU of the device head 100, i.e. in the visual range with close surroundings NU of the surgical camera 211. The image data 300 are provided to an image data processing unit 220. The basis of the method and device presented here now is the use of the employed intraoperative camera systems—as explained here in an exemplary manner by the surgical camera 211 as part of an endoscope 110—for obtaining navigation information from objects imaged in the camera image, i.e. the image data 300, in the whole image region, i.e. in the whole imaged region of the operation surroundings OU.

Denoted here as objects are a first, more rounded object OU1 and a second, more elongate object OU2. While the image data processing unit 220 is embodied to generate a surface model 310 of the operation surroundings OU by means of the image data 300, it is moreover possible for volume rendering data of a volume rendering 320 of the operation surroundings, predominantly obtained pre-surgery, to be present. The surface model 310 and the volume rendering 320 can be stored in suitable storage regions 231, 232 in an image storage unit 230. To this end, corresponding rendering data of the surface model 310 or rendering data of the volume rendering 320 are stored in the image storage unit 230. The target now is to bring specific surface points OS1, OS2 in the view of the two-dimensional camera image, i.e. in the surface model 310, into correspondence with a corresponding position of a volume point VP1, VP2 in the 3D image data of a patient, i.e. in the volume rendering 320; in general, it is the goal to register the surface model 310 to the volume rendering 320.

However, until now, it was initially necessary to separately show or identify suitable or possible surface points OS1, OS2 or volume points VP1, VP2 by a surgeon or any other user—subsequently, it is necessary to check with much outlay as to whether the volume point VP1 in fact corresponds to the surface point OS1 or the volume point VP2 corresponds to the surface point OS2. By way of example, the specific case can relate to the registration of video data, namely the image data 300 or the surface model 310 obtained therefrom, also 3D data obtained pre-surgery, such as e.g. CT data, i.e., in general, the volume rendering.

Until now, three substantial approaches for registration have proven their worth; these are in part described in detail below. A first approach uses a pointer, i.e. either as a physical hardware instrument (pointer) or, for example, as a laser pointer (pointer), in order to identify and localize specific surface points OS. A second approach uses the identification and visualization of surface points in a video or similar image data 300 and registers these, for example to a CT data record by means of a tracking system. A third approach identifies and visualizes surface points in a video or similar image data 300 and registers these to a volume rendering, such as e.g. a CT data record by reconstructing and registering the surface model 310 to the volume rendering 320 by suitable computing means. Until now, use was made of a surgical camera 211, for example merely to monitor or visualize a pointer instrument or a pointer or any other form of a manual indicator of a surface point, independently of the type of approach for matching the surface model 310 and the volume rendering 320 within the scope of image data processing. After this, computing means 240 are provided, which are embodied to match (register) the surface point OS1, OS2, identified by manual indication, to a volume point VP1, VP2 and thus correctly assign the surface model 310 to the volume rendering 320.

Going beyond this—in order to remove the difficulties connected with the manual interventions—the method and device described in the present embodiment provide virtual pointer means 250 within the scope of the image data processing unit 220, which virtual pointer means are embodied to automatically provide a number of surface points in the surface model 310; thus, it is not only a single one that is shown manually, but rather any number are shown in the whole operation surroundings OU. The number of surface points OS, particularly in the surface model 310, can be freely selectable; in particular, it can be provided in a manner free from a physical display. Additionally or alternatively, the number of surface points OS in the surface model 310 can also be set automatically. In particular, the selection can at least in part comprise an automatic pre-selection and/or an automatic final selection. A selection and/or monitoring means 500 is embodied to group an automatic selection, in particular in a pre-selection and/or a final selection, on the basis of the image data 300 and/or the surface model 310; by way of example, on the basis of first grouping parameters comprising: a distance measure, a 2D or 3D topography, a color. A selection and/or monitoring means 500 can also be embodied to group an automatic selection independently of the image data 300 and/or the surface model 310, in particular on the basis of second grouping parameters comprising: a geometry prescription, a grid prescription. The selection and/or monitoring means 500 has a MAN-machine interface MMI, which is actuatable for manual selection assistance.

Moreover, provision is made for registration means 260—as hardware and/or software implementations, e.g. in a number of modules—which are embodied to localize the surgical camera 211 relative to the surface model 310. In particular, measurement of the location KP2 and position KP1 (pose KP) of the employed surgical camera 211, shown by way of example in FIG. 5, is included, in particular, in the concept presented here in an exemplary manner as an embodiment.

Initially, the imaging properties of the image recording unit can be defined, as a matter of principle, in very different ways and these can preferably be used, like other properties of the image recording as well, for determining the location KP2 and position KP1 (pose KP). However, a combination of spatial coordinates and directional coordinates of the imaging system can preferably be used for a pose KP of an image recording unit. By way of example, a coordinate of a characterizing location of the imaging system, such as e.g. a focus KP1 of an imaging unit, e.g. a lens, of the image recording unit, is suitable as a spatial coordinate. By way of example, a coordinate of a directional vector of a visual beam, that is to say with reference to FIG. 5, for example, an alignment KP2 of the visual beam 330, is suitable as a directional coordinate.

This can be in relation to FIG. 2 using a computing process or within the scope of a position measurement system explained with reference to FIG. 3 which can operate e.g. on an optical, electromagnetic or mechanical basis. In both cases, the analysis includes knowledge of the imaging properties of the camera system and, in particular, of the surgical camera 211. This approach is explained in more detail in relation to FIG. 4 using an example.

Referring initially to FIG. 2, the latter elucidates an example for a video-based, aforementioned third approach for registering a volume rendering 320 on a surface model 310. The same reference signs are used in the present case for the same or similar parts, or for parts with the same or similar function.

FIG. 2 shows a tissue structure G with objects O1, O2 which are identifiable as a volume point VP in a volume rendering 320 or as a surface point OS in a surface model and which should be assigned to one another. An advantage of the system 1001, depicted in FIG. 2, of a surgical device is the use of a navigation method, referred to as visual navigation, without additional external position measurement systems. Here, a map is generated on the basis of image data 300, i.e. camera image data from a surgical camera 211, e.g. on an endoscope 110, and/or image data 300 of an external camera 212 of the surroundings U of the device head 100. This can be a map of the surroundings U and/or map comprising the surface model 310 of the operation region OU. In respect of the detailed description, reference is made to DE 10 2012 211 378.9, which was not published at the time of filing of the present application and the priority of which is prior to the filing date of the present application. The content of the application is herewith completely incorporated into the disclosure of this application by reference.

In particular, within the scope of the concept of the visual navigation elucidated in FIG. 2 in an exemplary manner, the implementation of a SLAM (simultaneous localization and mapping) method is described as an option which only uses sensor signals, in particular image data 300, for orientation in an extended region, namely the operation surroundings OU, on the basis of the map of the surroundings U and/or the map of the operation surroundings OU. On the basis of the sensor data, an inherent movement of the device head 100 is estimated and a map of the region registered by the internal camera 211 or external camera 212 is generated continuously. In addition to the map generation and movement identification, the currently registered sensor information is simultaneously monitored for correspondences with the previously stored image map data. If a correspondence is determined, the system is provided with the inherent current position and orientation (pose) within the map. As described in the aforementioned application, a monocular SLAM method is already suitable as an information source, in which method feature points are continuously registered in the video image and the movement thereof in the image is evaluated. If the surface map 310 as explained on the basis of FIG. 1 can now be registered to a volume data record 320 of the patient, the visualization of positions of objects OS1 in the video image is possible within the 3D image data VP. Likewise, the common use of the visual navigation using a conventional tracking method becomes possible in order to determine the absolute position of the generated surface map.

The accuracy of the navigation in the operation surroundings OU constitutes a disadvantage of this solution approach. The surface map to be generated for the navigation should reach from the region of the image data registration (e.g. face in the case of paranasal sinus interventions) to the operation surroundings (e.g. ethmoidal cells). As a result of the piecewise design of the map and the addition of new data on the basis of the available map material, errors in the map design can accumulate. Also, problems may occur if it is not possible to generate video image data with pronounced and traceable image content for specific regions of the operation region. A reliable generation of a precise surface map with the aid of the e.g. monocular SLAM method is therefore a precondition for providing a sufficient accuracy of surgical interventions.

FIG. 3 shows a modified system 1002 of a surgical device 1000 with a device head 100 and imaging system 200 in the application for a tissue structure G in a patient in a particularly preferred embodiment. In order to achieve the aforementioned requirements in respect of accuracy, pointer instruments to which localizers for registering the location are attached have previously been used for registering a 3D position of objects in OS in operation surroundings OU; these localizers can be registered by optical or electromagnetic position measurement systems. The background for this is that it is often necessary in the case of surgical interventions with intraoperative real-time imaging—as is the case in the endoscopy, depicted in an exemplary manner in FIG. 3, with an endoscope as a device head 100 or in a different laparoscopic application—to determine position information for structures depicted in the camera image and provide these to the surgeon or operating physician or any other user. The special navigation instruments (pointers) referred to as pointers with localizers are guided manually or by way of a robotic arm by the operating physician in order to scan a tissue structure G in the operation surroundings OU. A tissue position O2 of the surface point OS can be deduced by the surgeon or other user from the visualization of the pointer position in the image data 300. However, the use of special navigation instruments requires additional instrument changes during the intervention and therefore makes performing the operation and exact scanning of the tissue G by the operating physician more difficult.

A novel solution approach for determining image points in current image data 300 of intraoperative real-time imaging is proposed as an example in FIG. 3; it renders it possible to register a surface point OS to a volume point VP or, specifically, to bring a 3D position in the reference coordinate system of the 3D image data (volume rendering 320) of the patient, e.g. CT image data, into correspondence. To this end, as is visible in the present case from FIG. 3, the position of the surgical camera 211 and the position of the patient, and hence of the tissue structure G, in the operation surroundings OU is registered with the aid of a position measurement system 400. To this end, the position measurement system has a position measuring unit 410 which, for example, can be formed as an optical, electromagnetic or optical measurement unit; it also has a first localizer 420 and a second localizer 430. The first localizer 420 can be attached, as depicted in FIG. 3, to the endoscope 110 and, as a result thereof, represent a rigid, or in any case determined, connection 422 to the surgical camera 211 or it can preferably be attached directly, as depicted in FIG. 4, to a surgical camera 212 or a similar camera system provided externally from the endoscope 110. The localizers 420 and 410 and 430 are embodied as so-called optical trackers with localizer spheres and can be fastened to the exposed object of the endoscope 110 or the external surgical camera 212 or to the patient (and hence to the tissue structure G).

Possible camera systems are conventional cameras (e.g. endoscopes) but also 3D time-of-flight cameras or stereoscopic camera systems for embodying the surgical camera 211, 212.

In addition to a color or grayscale value image of the operation surroundings OU, time-of-flight cameras also supply an image with depth information. Hence, a surface model 310 can already be generated from a single image, which surface model enables the calculation of the 3D position of the surgical camera 211 relative to the endoscope optics for each 2D position in the image. With the aid of a suitable calibration it is possible to calculate the transformation of the 3D coordinates supplied by the camera (surface coordinate of the surface model rendering data) to the reference coordinate system R421 or R420 of the camera localizer or instrument localizer 421, 420.

Stereoscopic camera systems simultaneously supply camera images of the operation surroundings from two slightly deviating positions and therefore enable a reconstruction of a 3D surface as a surface model 310 of the objects depicted in the camera images. After calibration of the camera system, the surface model 310 reconstructed on the basis of one or more image pairs can be realized e.g. as a point cloud and referenced to the localizer 420, 421; as is by way of suitable transformations TLL1, TLK.

Conventional camera systems render it possible to reconstruct a surface model 310 of the object OS depicted in the image data 300 on the basis of image sequences of a calibrated camera, which is tracked by position measurement systems, when there is sufficient movement of the camera and a sufficient amount of prominent image content. These methods are similar to the monocular SLAM method explained above. However, in the present case, the position, in particular the pose, of the camera need not be estimated but can instead be established by the position measurement system 400. In this respect, the embodiment of FIG. 3 and FIG. 4 constitutes a modification of the embodiment in FIG. 2.

Thus, a surface model of the operation surroundings OU, which in this case is visualized from the registration region KOU of the camera system, i.e. which substantially lies within the outer limits of the field of view of the surgical camera 211, 212, is rendered by means of the surgical camera 211, 212—based on a sequence of one or more successive camera images. 3D positions O1 for any 2D image positions O2 in the image data 300 are calculated on the basis of this surface model 310. Then, after successful registration of the 3D patient image data to the patient localizer 430, 3D coordinates can be transformed into the reference coordinate system of the 3D image data 320 with the aid of the position measurement system 400 or the position measurement unit 410. The subsequent case refers to the reference coordinate system R430 of the object localizer 430, i.e. of the 3D image data of the patient 320. In the present case, the reference coordinate systems R420 and R421 of the camera localizer 420, 421 are also referred to as the reference coordinate system R212 of the surgical camera 212, which merge into one another by simple transformation TKL.

The principle of the navigation process elucidated in FIG. 3 and in FIG. 4 consists of establishing a corresponding 3D position, namely a volume coordinate in the volume rendering data, in the pre-operative or intraoperative volume image data of the patient for the pixels in the camera image, i.e. the image data 300 or in the associated surface model. The endoscope is localized relative to the patient with the aid of an external position measurement system 400 with use of the above-described optical measurement unit 410 with the reference coordinate system R410 assigned thereto. As explained above, the optical measurement units can be realized with different camera technology for generating a surface model 310, as required.

The 3D position of an image point, established from the camera image data, is transformed with the aid of transformations TKL, TLL1 (transformation between the reference coordinate systems of the camera localizer and the position measurement system), TLL2 (transformation between the reference coordinate systems of the object localizer and the position measurement system) and TLL3 (transformation between the reference coordinate systems of the 3D image data and the object localizer), which are forwarded by measurement, registration and calibration, and it can then be used for visualization purposes. Here, G denotes the object of a tissue structure depicted in the camera image data. The localizers 420, 421, 430 have optical trackers 420T, 421T, 430T embodied as spheres which can be registered by the position measurement system 400 together with the associated object (endoscope 110, camera 212, tissue structure G).

FIG. 3 and FIG. 4 depicts the volume renderings 320 with the reference coordinate system R320 assigned thereto, the latter emerging from the reference coordinate system R430 of the tissue structure G by means of the indicated transformation TLL3. Using this, it is finally possible to bring the reference coordinate system R212 of the image data 300 into correspondence with the reference coordinate system of the volume rendering 320. The volume rendering can be realized as a collection of volume coordinates of the volume rendering data, e.g. for CT, DVT or MRI image; in this respect, the volume rendering 320 depicted as a cube is an exemplary rendering of 3D image data of the patient.

FIG. 5 depicts the objects, used by the concept explained in an exemplary manner, and the functional principle in conjunction with an optical position measurement system. The main component of the present concept is, as explained, the surgical camera 211, 212 with the reference coordinate system R420 or R421, R212 (via transformation TKL) assigned thereto. The location of the surgical camera can e.g. be implemented in a purely computational manner by way of a SLAM method—as explained on the basis of FIG. 2—or it can be registered with the aid of a localizer 420, 421 within the scope of the position measurement system 400—as explained on the basis of FIG. 3 and FIG. 4. Here, the position of the camera origin (e.g. the main lens) and the alignment or viewing direction of the camera represents the camera coordinate system R212; the latter emerges relative to the reference coordinate system R421, R420 of the camera localizer by calibration, measurement or from reconstructing the arrangement (dimension of the camera, imaging geometries and dimensions of the camera, dimension of the endoscope 110).

The surgical camera 211, 212 is aligned onto a tissue structure G by the surgeon or any other user, the location of which tissue structure can likewise be established with the aid of the localizer 430 securely connected thereto. The camera image data, i.e. image data 300 which image the tissue structure G, are evaluated and used to render the surface model 310 of the operation region OU shown in FIG. 1. The 3D position can then be determined with the aid of the surface model 310 as a surface coordinate of the surface model rendering data for a specific image point in the reference coordinate system of the camera R212 or R421, R420. To this end, it is possible, for example on the basis of the results of the camera calibration, to calculate a visual beam 330, depicted in FIG. 5, for a desired image point 301 of the image data 300 of the camera image. The sought-after 3D position as a surface coordinate of the surface model rendering data can thus be established as point of intersection between the visual beam 330 and the surface model 310 as point 311. In this respect, the image data 300 represent the camera image positioned in the focal plane of the surgical camera 211, 212.

The embodiments described in FIG. 3 to FIG. 5 have significant advantages in terms of accuracy over the embodiment depicted in FIG. 2 and can also continue to be operated in the case of a brief outage of the position measurement system 400. An outage of the position measurement system 400 may occur, for example, if there is an interruption in the visual contact between the optical measurement unit 410 and the localizers 420, 430, 421. In that case, however, it is possible to use the previously generated surface model 310 in order to establish the camera position—i.e. comprising pose KP of focus coordinates KP1 and alignment KP2 of the visual beam 330—relative to the patient or the tissue structure G. To this end, the current topology of the operation surroundings OU can be established relative to the surgical camera 211, 212 on the basis of a camera image, i.e. the image data 300 or an image sequence of same. These data, e.g. surface coordinates of a point cloud of the surface model 310, can then be registered to the existing surface model 310. As a result of the known transformation of patient localizer 430 to the 3D image data 320 and to the existing surface model 310, the 3D positions of any image point OS1, OS2, and also of the camera 211, 212 itself, can be calculated in the volume image data 320 and therefore ensure a continuing navigation assistance for the surgeon or other user.

The target of this method is to automatically identify one or more image positions of interest, which are then used for a subsequent manual, or else automatic, final selection of the image position. In the following, an exemplary selection of steps is explained with reference to FIG. 5, which steps enable a selection, in particular a pre-selection and final selection, of the navigated image positions. The presented process renders it possible to perform the calculation and visualization of the 3D position in the patient for various 2D positions in the camera image. In this application, it is necessary to select a point for which the navigation information is calculated and rendered. The automatic and manual processes as set out below are suitable to this end; the following criteria can be taken into account as basis for the automatic pre-selection of image positions:
distance between the camera and the structures rendered in the image
3D topography of the rendered structures on the basis of the generated surface model (form or depth gradients)
color or color change of the rendered structures in the video image. Alternatively, it is also possible to use a set of image positions as a pre-selection, which are predetermined by the system independently of the image content or the surface model. Here, e.g. a geometric distribution of the image points in a rectangular or circular grid is feasible.

The following evaluation methods can be used for the automatic final selection of the image position for calculating the 3D position in the volume image data:
an evaluation of the image positions on the basis of the criteria mentioned in relation to the automatic pre-selection
an evaluation on the basis of a statistical analysis of previous selected in the positions. Here, it is feasible to use, inter alia, the following mathematical processes:
Kalman filter or fuzzy processes
Neural networks.

The manual processes are characterized by the inclusion of the user. The following methods are suitable for the manual selection of an image position, possibly with use of a preceding automatic pre-selection of image positions:
Mouse interaction on the screen of the navigation instrument: the operating physician or an assistant clicks on the desired position in the depicted video image. The corresponding 3D position is subsequently established and displayed for this selected image position.
Gesture control: with the aid of a suitable sensor system (e.g. PMD camera or Microsoft Kinect) it is possible to register and evaluate the movement of the user. Using this, it is possible e.g. to track the hand movement and interpret it as a gesture which enables the selection of the desired 2D image point. By way of example, a hand movement to the left can likewise displace the image position to be controlled to the left. Alternatively, the final selection of the predetermined image position could be controlled using the gesture control in the case of a preceding automatic pre-selection of image positions.
Foot pedal control: with the aid of a foot pedal, the user can control the final selection of the predetermined image position from image positions from a preceding automatic pre-selection. If the operating physician steps on a foot pedal, the selection of the selected image position, which is used for calculating and visualizing a 3D position on the patient, changes.
Voice control: like in the case of the gesture control, the selected image position can be displaced directly by voice commands. By way of example, the voice command “left” could bring about displacement of the 2D image position to the left by a predetermined offset.
Touchscreen: if the camera image is displayed on a touchscreen or multitouch screen, the user can select the 2D image position directly on the screen by touching this position.
Mechanical input means: if mechanical input means are connected to the navigation system (e.g. keyboard, control buttons), the user can control the 2D image position by way of these input means. Here, it is possible to trigger either a displacement of the current image position or a change in the selection in a set of pre-selected image positions.

Thus, in principle, the novelty of this concept lies in the option of calculating the corresponding 3D position in the volume image data for any 2D positions in the image data of a tracked camera which is used intraoperatively. Furthermore, the described methods for selecting or setting the 2D position in the camera image, for which the 3D information is intended to be calculated and displayed, are novel. A navigation system visualizes location information in 3D image data of the patient for any image position of the camera image data. Medical engineering, in particular, counts as technical field of application, but the latter also includes all other applications in which an instrument-like system according to the above-described principle is used.

In detail, FIG. 6 shows a surgical device 1000 with a device head 100, as was already rendered on the basis of FIG. 1, and an exemplary image rendering of a monitor module in versions (A), (B), (C) and also, in detail, a rendering of image data 300, surface model 310 or volume rendering 320 or a combination thereof.

For version (A), the surface model 310 is combined with the volume rendering 320 by way of a computer means 240. In the present case, the referenced rendering of surface model 310 with the volume rendering 320 also materializes as a pose of the surgical camera 211 because the selection and/or monitoring means provides image data 300 with an automatic selection of surface points OS1, OS2, which can be selected by way of a mouse pointer 501 of the monitoring module 500. To this end, the option of a mouse pointer 501′ is selected in the selection menu 520 of the monitoring module 500. The surface points OS1, OS2 can be predetermined according to the monitoring module by way of a distance measure or topography or a color rendering in the image data.

A geometry prescription 521 can be placed by way of the selection menu 510 in version (B); in this case, it is a circular prescription such that only the surface point OS1 is shown to the extent that the final selection is set. In a third development, a grid selection 531 can be selected in a selection menu 530, for example for displaying all structures in the second quadrant x—this leads to only displaying the second surface point OS2.

FIG. 7 shows a preferred sequence of steps for performing a method for medical navigation of any image point in medical camera image data 300. It is to be understood that each one of the method steps explained in the following can also be implemented as an action unit within the scope of a computer program product embodied to execute the explained method step. Each one of the action units identifiable from FIG. 7 can be implemented within the scope of an aforementioned image processing unit, image storage unit and/or navigation unit. In particular, the action units are suitable for implementation in a registration means, a virtual pointer means and a correspondingly embodied computer means; i.e. registration means, which are embodied to localize the surgical camera relative to the surface model; virtual pointer means, which are embodied to automatically provide a number of surface points in the surface model; computer means, which are embodied to automatically assign to at least one of the provided surface points the volume point of the volume rendering.

Proceeding from a node point K1, a pre-operatively generated volume rendering 320 with volume rendering data is provided in a first step VS1 of the method; in this case, for example, in a storage unit 232 of an image storage unit 230. In a second method step VS2, proceeding from the node point K2, image data 300 are provided as camera image data of a surgical camera 211, 212, from which image data a surface model 310 can be generated by way of the image data processing unit 220 rendered in FIG. 1 and stored in a storage unit 231 of the image data storage unit 230 within a method step VS3. In a fourth method step VS4, proceeding from the node point K3, there is a camera registration by means of registration means, in particular within the scope of a position measurement system 400 and/or a visual navigation, for example by using a SLAM method. To this end, in particular, the pose KP of the surgical camera 211, 212 is stored—namely the focus coordinates KP1 in a method step VS4.1 and the alignment KP2 in a method step VS4.2. A virtual pointer means, such as e.g. a visual beam 330 can be provided as a virtual pointer means in a fifth method step VS5. In general, a number of surface points in the surface model can automatically be provided with the virtual pointer means. To this end, provision is made for using the known imaging properties of the camera and the form and relative position of the surface model in order to determine a selection of surface points. In this specific case, the surface point 311 can be set as a point of intersection between a virtual visual beam 330 emanating from the surgical camera 211, 212 and the surface model 310, in particular a surface coordinate which specifies an image point 301 of the surgical camera 211, 212 associated with the point of intersection. In a sixth method step VS6, it is possible—by using suitable transformations; TKL, TLL1, TLL2, TLL3 above—to reference the volume rendering 320 and the surface model 310 by way of a computer module 240. Alternatively, or in combination, it is possible to provide a pre-selection and/or final selection of all objects coming into question—in particular surface points and/or volume points US, VP—by means of a selection and/or monitoring means in a seventh method step VS7.1, VS7.2. In an eighth method step VS8, a rendering of the selected points can be implemented with referencing the camera 211 and the volume and surface rendering 320, 310 on an output module, as was explained, for example, on the basis of FIG. 6. At the node point K3, there can be a loop, for example to the aforementioned node points K1 and/or K2, in order to let the method run through completely from the start. Moreover, a loop can be formed to only one of the node points K1, K2. Also, only part of the method may be repeatable, e.g. if a camera position changes, such that, for example, a loop can be implemented to the node point K3 and the method step VS4. Also, it may be the case that only the selection sequence is repeatable such that a loop is performable to the method step VS7.

### LIST OF REFERENCE SIGNS

100 Device head
110 Endoscope
200 Imaging system
210 Image data registration unit
211, 212 Surgical camera
220 Image data processing unit
230 Image storage unit
231, 232 Storage region
240 Computer means
250 Pointer means
260 Registration means
300 Image data
301 Image point
310 Surface model
311 Point of intersection
320 Volume rendering
330 Visual beam
400 Position measurement system
410 Position measurement unit
420, 421, 430 Localizer
422 Determined connection
420T, 421T, 430T Tracker
500 Selection and monitoring means
501, 501′ Mouse pointer
510, 520, 530 Selection menu
521 Geometry prescription
531 Grid prescription
1000 Surgical device
1001 System with a surgical device
1002 Modified system with a surgical device
G Tissue structure
KP Camera position, pose
KP1 Position, focus coordinates
KP2 Alignment
O2 Tissue position
OS, OS1, OS2 Surface point
OU Operation surroundings
OU1 Round object
OU2 Elongate object
R212, R320, R410, R420, R421, R430 Reference coordinate system
TKL Transformation
TLL1 Transformation between the reference coordinate systems of the camera localizer and the position measurement system
TLL2 Transformation between the reference coordinate systems of the object localizer and the position measurement system
TLL3 Transformation between the reference coordinate systems of the 3D image data and the object localizer
U Surroundings
VP, VP1, VP2 Volume points

1. An imaging system, in particular for a surgical device with a mobile handheld device head, comprising:
an image data acquisition unit with an image recording unit, in particular a surgical camera, which is embodied to register image data of operation surroundings,
an image data processing unit, which is embodied to provide the image data,
an image storage unit, which is embodied to store the image data of the operation surroundings and volume data of a volume rendering associated with the operation surroundings,
furthermore characterized by
registration means, which are embodied to localize the image recording unit, in particular the surgical camera, relative to the operation surroundings,
virtual pointer means, which are embodied automatically to provide a number of image points of the image data, and
assignment means, in particular with computer means, which are embodied to assign to at least one of the provided image points automatically a volume point of the volume rendering.

2. The system as claimed in claim 1, characterized in that the image recording unit is embodied to register image data of the operation surroundings continuously and/or the image data of the operation surroundings are recordable at a device head.

3. The system as claimed in claim 1, characterized in that the image recording unit is formed as a surgical camera, in particular an optical surgical camera.

4. The system as claimed in claim 1, characterized in that the image points are formed as surface points from the image data and
the image data processing unit is embodied to generate a surface model of the operation surroundings by means of the image data, and/or
an image storage unit is embodied to store the surface model rendering data, and/or
the registration means are embodied to localize the surgical camera relative to the surface model of the operation surroundings, and/or
the virtual pointer means are embodied to provide a number of surface points in the surface model.

5. The system as claimed in claim 1, characterized in that the image data comprise surface rendering data, in particular of a surface model, preferably for determining surface points, and/or the volume data comprise volume rendering data.

6. The system as claimed in claim 1, characterized in that the virtual pointer means are embodied to provide a number of image points of the image data, in particular surface points, in particular of the surface model, automatically by virtue of these being identified and/or displayed.

7. The system as claimed in claim 1, characterized in that the registration means comprises a position measuring system, in particular an optical or electromagnetic localizer registration system, which comprises:
a physical patient localizer, a physical camera localizer, in particular a physical instrument localizer.

8. The system as claimed in claim 1, characterized in that the registration means comprises a number of registration modules, in particular as part of the image data acquisition unit, the image data processing unit and/or a navigation unit, wherein:
a first registration module, in particular the image data acquisition unit, is embodied to register and provide, in particular continuously, image data of surroundings of the device head and
a second registration module, in particular the image data processing unit, is embodied to generate a map of the surroundings by means of the image data and
a third registration module, in particular a navigation unit, is embodied, by means of the image data and an image stream, to specify at least one position of the device head in close surroundings of the operation surroundings on the basis of the map in such a way that the mobile device head is guidable on the basis of the map.

9. The system as claimed in claim 1, characterized in that a guide means with a position reference to the device head and assigned thereto is embodied to provide information in relation to the position of the device head with reference to the surroundings in the map, wherein the surroundings go beyond the close surroundings.

10. The system as claimed in claim 1, characterized in that a surface coordinate in surface model rendering data is assigned to the surface point in the surface model and a volume coordinate in the volume rendering data is assigned to the volume point of the volume rendering.

11. The system as claimed in claim 1, characterized in that the surface point can be set as a point of intersection between an assignment means emanating from the surgical camera and the image data, in particular it can be set as a point of intersection between a virtual visual beam emanating from the surgical camera and the surface model, in particular it specifies a surface coordinate of an image point of the image data of the surgical camera, assigned to the point of intersection.

12. The system as claimed in claim 1, furthermore characterized by a selection and/or monitoring means, which is embodied to group a freely selectable and automatically provided and set number of image points, in particular surface points, into a selection and to visualize the selection in a selection rendering.

13. The system as claimed in claim 1, characterized in that
the number of image points, in particular surface points in the surface model, is providable in a freely selectable manner, in particular free from a physical display, and/or
the number of image points, in particular surface points in the surface model, can automatically be set, and/or
the selection comprises, at least in part, an automatic pre-selection and/or an automatic final selection.

14. The system as claimed in claim 12, characterized in that a selection and/or monitoring means is embodied to group the automatic selection, in particular in a pre-selection and/or final selection, on the basis of the image data and/or the surface model, in particular on the basis of first grouping parameters comprising: a distance measurement, a 2D or 3D topography, a color.

15. The system as claimed in claim 12, characterized in that a selection and/or monitoring means is embodied to group an automatic selection independently of the image data and/or the surface model, in particular on the basis of second grouping parameters comprising: a geometry prescription, a grid prescription.

16. The system as claimed in claim 12, characterized in that a selection and/or monitoring means is embodied to group an automatic selection, in particular a final selection, by means of evaluation methods, in particular comprising:
evaluation methods with statistical evaluation and/or filtering of the preselected surface points, in particular by means of a Kalman filter, a fuzzy logic and/or a neural network.

17. The system as claimed in claim 12, characterized in that the selection and/or monitoring means has a MAN-machine interface, which is actuatable for manual selection support, in particular by one or more of the input features selected from the group comprising: keyboard means for hand or foot, such as mouse, button, pointer or the like, a gesture sensor, a voice sensor, a touch-sensitive sensor such as an input pad, a touchscreen, a mechanical input means.

18. A surgical device with an imaging system as claimed in claim 1, in particular comprising a mobile handheld device head.

19. An imaging method (FIG. 7), in particular for a surgical device as claimed in claim 18, comprising the following steps:
registering and providing image data of operation surroundings, in particular generating a surface model of the operation surroundings by means of the image data,
storing the image data of the operation surroundings and volume data of a volume rendering assigned to the operation surroundings,
furthermore characterized by the following steps:
localizing an image recording unit, in particular the surgical camera, relative to the operation surroundings,
displaying a number of image points, in particular surface points, of the image data in a virtual automatic manner,
automatically assigning at least one of the provided image points, in particular surface points, to a volume point of the volume rendering.

20. The method as claimed in claim 19, characterized in that the surface point is set as a point of intersection between a virtual visual beam emanating from the surgical camera and the surface model, in particular that it specifies a surface coordinate of the image point, assigned to the point of intersection, of the image data of the surgical camera.

21. The method as claimed in claim 19, further characterized by grouping a freely selectable and automatically provided and set number of image points, in particular surface points, in a selection and visualizing of the selection in a selection rendering.

22. The method as claimed in claim 19, characterized in that the number of image points, in particular surface points in the surface model is freely selected, in particular provided free from a physical display.

23. The method as claimed in claim 19, characterized in that the number of image points, in particular surface points in the surface model, is set automatically.

24. The system as claimed in claim 2, characterized:
in that the image recording unit is formed as a surgical camera, in particular an optical surgical camera;
in that the image points are formed as surface points from the image data and
the image data processing unit is embodied to generate a surface model of the operation surroundings by means of the image data, and/or
an image storage unit is embodied to store the surface model rendering data, and/or
the registration means are embodied to localize the surgical camera relative to the surface model of the operation surroundings, and/or
the virtual pointer means are embodied to provide a number of surface points in the surface model;
in that the image data comprise surface rendering data, in particular of a surface model, preferably for determining surface points, and/or the volume data comprise volume rendering data;
in that the virtual pointer means are embodied to provide a number of image points of the image data, in particular surface points, in particular of the surface model, automatically by virtue of these being identified and/or displayed;
in that the registration means comprises a position measuring system, in particular an optical or electromagnetic localizer registration system, which comprises:
a physical patient localizer, a physical camera localizer, in particular a physical instrument localizer;
in that the registration means comprises a number of registration modules, in particular as part of the image data acquisition unit, the image data processing unit and/or a navigation unit, wherein:
a first registration module, in particular the image data acquisition unit, is embodied to register and provide, in particular continuously, image data of surroundings of the device head and
a second registration module, in particular the image data processing unit, is embodied to generate a map of the surroundings by means of the image data and
a third registration module, in particular a navigation unit, is embodied, by means of the image data and an image stream, to specify at least one position of the device head in close surroundings of the operation surroundings on the basis of the map in such a way that the mobile device head is guidable on the basis of the map;
in that a guide means with a position reference to the device head and assigned thereto is embodied to provide information in relation to the position of the device head with reference to the surroundings in the map, wherein the surroundings go beyond the close surroundings;
in that a surface coordinate in surface model rendering data is assigned to the surface point in the surface model and a volume coordinate in the volume rendering data is assigned to the volume point of the volume rendering;
in that the surface point can be set as a point of intersection between an assignment means emanating from the surgical camera and the image data, in particular it can be set as a point of intersection between a virtual visual beam emanating from the surgical camera and the surface model, in particular it specifies a surface coordinate of an image point of the image data of the surgical camera assigned to the point of intersection;
furthermore characterized by a selection and/or monitoring means, which is embodied to group a freely selectable and automatically provided and set number of image points, in particular surface points, into a selection and to visualize the selection in a selection rendering;
in that
the number of image points, in particular surface points in the surface model, is providable in a freely selectable manner, in particular free from a physical display, and/or
the number of image points, in particular surface points in the surface model, can automatically be set, and/or
the selection comprises, at least in part, an automatic pre-selection and/or an automatic final selection;
in that a selection and/or monitoring means is embodied to group the automatic selection, in particular in a pre-selection and/or final selection, on the basis of the image data and/or the surface model, in particular on the basis of first grouping parameters comprising: a distance measurement, a 2D or 3D topography, a color;
in that a selection and/or monitoring means is embodied to group an automatic selection independently of the image data and/or the surface model, in particular on the basis of second grouping parameters comprising: a geometry prescription, a grid prescription;
in that a selection and/or monitoring means is embodied to group an automatic selection, in particular a final selection, by means of evaluation methods, in particular comprising: evaluation methods with statistical evaluation and/or filtering of the preselected surface points, in particular by means of a Kalman filter, a fuzzy logic and/or a neural network;
in that the selection and/or monitoring means has a MAN-machine interface, which is actuatable for manual selection support, in particular by one or more of the input features selected from the group comprising: keyboard means for hand or foot, such as mouse, button, pointer or the like, a gesture sensor, a voice sensor, a touch-sensitive sensor such as an input pad, a touchscreen, a mechanical input means.

25. A surgical device with an imaging system as claimed in claim 24, in particular comprising a mobile handheld device head.

26. An imaging method (FIG. 7), in particular for a surgical device as claimed in claim 25, comprising the following steps:
registering and providing image data of operation surroundings, in particular generating a surface model of the operation surroundings by means of the image data,
storing the image data of the operation surroundings and volume data of a volume rendering assigned to the operation surroundings, furthermore characterized by the following steps:
localizing an image recording unit, in particular the surgical camera, relative to the operation surroundings,
displaying a number of image points, in particular surface points, of the image data in a virtual automatic manner,
automatically assigning at least one of the provided image points, in particular surface points, to a volume point of the volume rendering.

27. The method as claimed in claim 26, characterized in that the surface point is set as a point of intersection between a virtual visual beam emanating from the surgical camera and the surface model, in particular that it specifies a surface coordinate of the image point, assigned to the point of intersection, of the image data of the surgical camera.

28. The method as claimed in claim 27, further characterized:
by grouping a freely selectable and automatically provided and set number of image points, in particular surface points, in a selection and visualizing of the selection in a selection rendering;
in that the number of image points, in particular surface points in the surface model is freely selected, in particular provided free from a physical display;
in that the number of image points, in particular surface points in the surface model, is set automatically.
